(19) United States
(12) Patent Application Publication
(10) Pub. No.: US 2011/0315840 A1
(43) Pub. Date: Dec. 29, 2011

(54) UNIVERSAL CAM LOCK MOUNT

(76) Inventors: DAN CONNOLLY, Kunshun Jiangsu (CN); Carlos Renderos, Alberta (CA); Shannon Lundrigan, Alberta (CA); Matko Papic, Alberta (CA)

(21) Appl. No.: 12/824,370

(22) Filed: Jun. 28, 2010

(51) Int. Cl. F16M 13/02; F16B 2/02; F16M 13/00

(52) U.S. Cl. 248/220.31; 248/309.1; 248/274.1; 24/458

(57) ABSTRACT

The present invention is directed to mounting devices, and in particular to a universal tool-less cam lock mount for releasably mounting an object on a structure, including structures of the type commonly referred to as a “slatwall”. The present mount comprises a mount housing, first and second engagement members, and a cam lock assembly. The cam lock assembly comprises a cam mechanism having a cam for moving at least one of the engagement members between at least a locked position and an unlocked position as the cam is rotated.

### FIELD

The present invention relates to mounting devices, and in particular to a universal mount comprising a cam lock for releasably mounting an accessory on a structure, including structures of the type commonly referred to as a “slatwall”.

### BACKGROUND

Slatwalls and slatwall systems are known in the art. A slatwall is adapted to removably support one or more objects, and typically comprises a surface having a plurality of substantially parallel and regularly spaced tracks or grooves therein. The grooves are adapted to receive and retain support members, such as hooks, brackets, or other engagement members. The parallel grooves can run in any desired direction, but it is common for them to run in a horizontal direction. One advantage of a slatwall system is its versatility. It allows a user to position one or more objects or accessories on the slatwall in any desired arrangement.

A mount, accessory or other object that is to be supported on a slatwall can be specially built to engage a slatwall. Alternatively, the object can be connected to a mount or bracket that is adapted to engage the slatwall.

Slatwalls are used in a multitude of different fields and applications for a variety of purposes. For example, slatwalls are used in retail store shelving and display units. They are also employed in commercial and personal storage systems, wherein any number of hangers, brackets or storage containers can be mounted on a slatwall. Slatwall systems are also used for mounting equipment and accessories in offices, homes, laboratories, workshops and vehicles. Examples of such equipment include but are not limited to electronics such as computers, displays, input devices, laboratory equipment and other accessories such as lamps, shelves and containers.

Mounts for mounting objects and accessories on a slatwall are also known in the art. One type of slatwall mount is a simple mount comprising a hook or a flange extending from a base member. Such a mount is installed on a slatwall by inserting the hook or flange into a groove in the slatwall and rotating the mount towards the slatwall until the base bears against the front surface of the slatwall. The mount is removed by pulling the base member away from the slatwall and withdrawing the hook or flange from the groove. Such mounts are generally simple in construction and are typically easy to install and remove from the slatwall. However, these simple mounts are generally not suitable where a more secure engagement between the mount and the slatwall is desired.

In certain applications it is desirable that the mount be securely connected to the slatwall or other surface to prevent any movement of the mount relative to the slatwall or surface, or to prevent partial or complete disengagement of the mount. For example, a secure engagement may be desirable where the slatwall system is installed in or on a vehicle, or is installed in any other environment that is exposed to vibrations or other movements. A secure engagement may also be desirable where there is a concern that the object could be inadvertently disengaged from the slatwall. For example, this could be the case where the object to be mounted is large, heavy, fragile or expensive. In such situations, a secure or “locking” mount can be employed. A locking mount can comprise two or more hooks, flanges, or other engagement members for engagement with one or more grooves in the slatwall. The two or more engagement members typically cooperate to secure the mount to the slatwall. In the instance of a mount having two engagement members, a first engagement member is usually moveable relative to a second engagement member. During the installation of such a mount on a slatwall, the first and second members are inserted into the groove(s). The second member is then moved relative the first member until both members have firmly engaged the groove(s), thereby securely engaging the mount to the slatwall.

A locking type of mount is disclosed in U.S. Pat. No. 7,066,435 to Oddsen, Jr. et al. This mount comprises a main body and a pair of clip assemblies for connecting the mount to a slatwall. First and second clips are inserted into two different grooves in the slatwall. The second clip is then moved relative to the first clip by way of a threaded bolt. The head of the bolt preferably includes a slot or a socket so that the bolt can be turned with a screwdriver or wrench.

The mount disclosed by Oddsen and other existing mounts suffer from the drawback of requiring a tool for engagement and disengagement with the slatwall. A tool-less locking mount, on the other hand, can reduce the amount of effort and time required to engage and disengage the mount with a slatwall. Furthermore, with a tool-less mount there is no concern over locating and storing the tool(s).

For the foregoing reasons, it can be appreciated that a need exists for tool-less locking mount adapted to engage a surface or structure, including a slatwall-type structure.

### SUMMARY

The present disclosure provides a universal mount comprising a cam lock for releasably mounting an object on a structure, including structures of the type commonly referred to as a “slatwall”.

According to the present invention then, there is provided a cam lock mount for mounting an object on a structure having at least a first surface and a second surface, the cam lock mount comprising a mount housing; a first engagement member coupled to the mount housing for engaging the first surface of the structure; a second engagement member for engaging the second surface of the structure, the second engagement member coupled to the mount housing at a spaced apart location from the first engagement member; a cam lock assembly supported by the mount housing and comprising a rotatable cam mechanism having cam means for moving at least one of the first engagement member and the second engagement member between at least a locked position connecting said mount to the structure and an unlocked position in which the mount is not connected to the structure, as the cam means are rotates.

### BRIEF DESCRIPTION OF THE DRAWINGS

Preferred embodiments of the present invention will now be described in greater detail and will be better understood when read in conjunction with the drawings in which:

FIG. 1A is a rear perspective view of one embodiment of the present cam lock mount in a locked state;

FIG. 1B is a rear perspective view of the embodiment shown in FIG. 1A with the back plate removed;

FIG. 1C is a rear perspective view of the mount housing of the embodiment shown in FIG. 1A;

FIG. 2A is a side sectional view of the embodiment shown in FIG. 1A in a locked state;

FIG. 2B is a side sectional view of the embodiment shown in FIG. 1A in an unlocked state;

FIG. 3 is an exploded perspective view of the embodiment shown in FIG. 1A;

FIG. 4 is a side sectional view of the embodiment shown in FIG. 1A engaged with a slatwall;

FIG. 5A is a front view of the embodiment shown in FIG. 1A;

FIG. 5B is a side sectional view of another embodiment of the present cam lock mount with an integrally formed mounting assembly;

FIG. 5C is a perspective view of an accessory; and

FIG. 5D is a side sectional view of the mount of FIG. 1A connected to the accessory shown in FIG. 5C.

### DETAILED DESCRIPTION

The present cam lock mount is described in one embodiment in the following disclosure with reference to the Figures. While this embodiment is described in the context of a cam lock mount adapted for use with a slatwall, the scope of the present disclosure is not intended to be limited to mounts for slatwalls. The present cam lock mount can be used to mount accessories or other objects to other structures and surfaces, including but not limited to racks, rails, poles, and frames.

The various features and components of the present cam lock mount are now described with reference to the Figures.

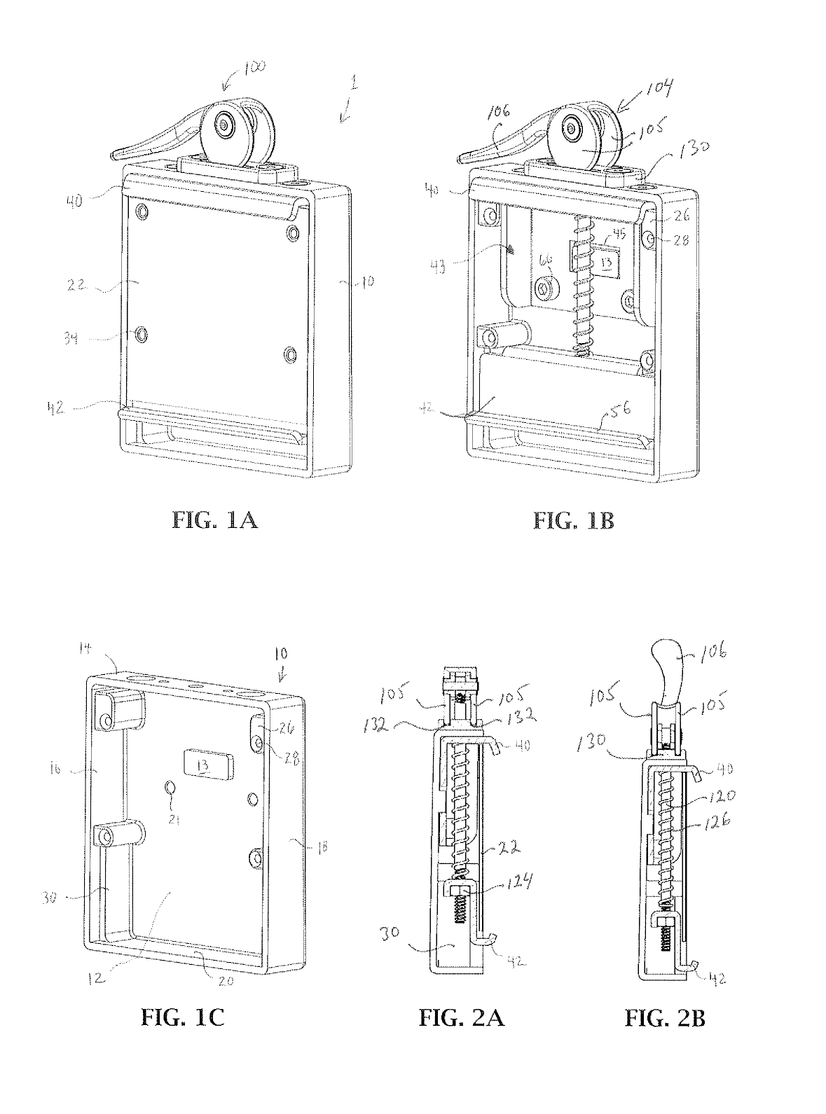

FIG. 1A shows one embodiment of the cam lock mount 1, which generally comprises a mount housing 10, a first fixed position engagement member 40, a second movable engagement member 42, and a cam lock assembly 100 to move engagement member 42 between an unlocked position shown in FIG. 2B and a locked position shown in FIGS. 1A, 1B and 2A, as will be described in greater detail below. For a better understanding of how mount 1 securely engages a structure or surface, such as a slatwall, FIG. 4 shows a cross sectional view of mount 1 engaged with a slatwall 300.

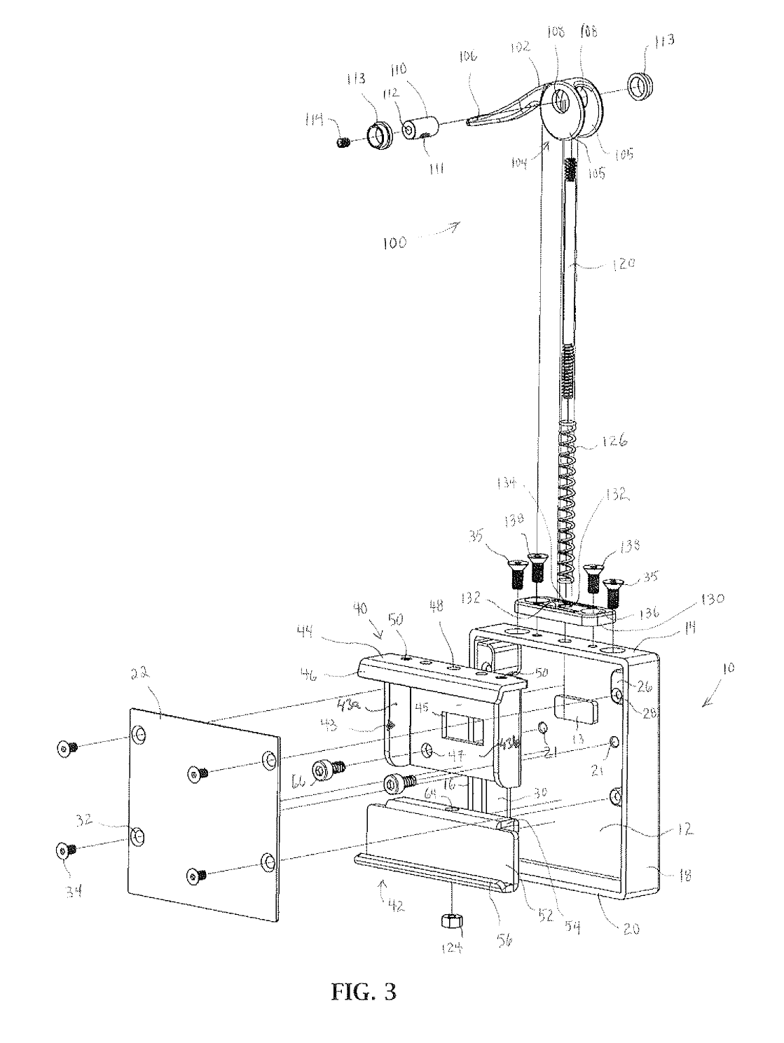

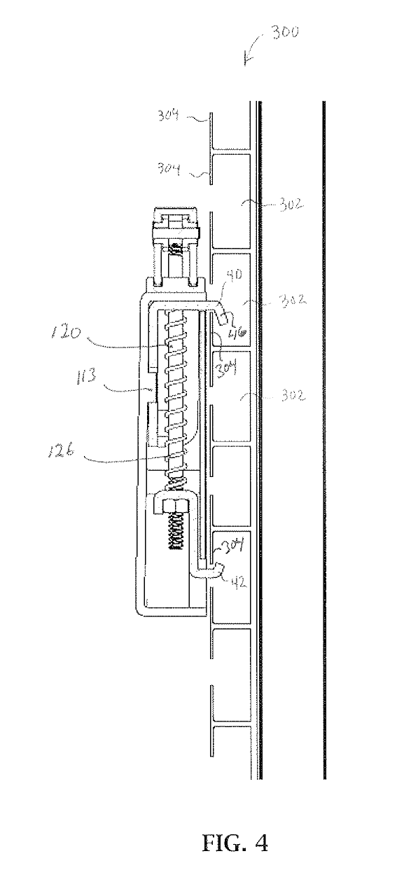

With reference now to FIG. 3, in at least one embodiment of the mount, mount housing 10 comprises a front wall 12, upper and lower walls 14 and 20 respectively, side walls 16 and 18, and a removable rear plate 22. The front, side, and upper and lower walls can be separate pieces connected to one another at their edges. Alternatively, these walls can be integrally formed from one or more pieces of material or materials (e.g. cast or form moulded, machined, etc.). Mount housing 10 can be made of metal, such as aluminum, or plastic, or of any other suitable material known in the art. Rear plate 22 can be connected to mount housing 10 by way of one or more fasteners 34, which can be received through fastener holes 32 in rear plate 22. As best shown in FIGS. 1B, 1C and 3, mount housing 10 includes shoulder members 26 disposed in the interior of housing 10 and positioned so as to not interfere with the movement of second engagement member 42 or any components of cam lock assembly 100, as will be described below. Each shoulder member 26 includes a hole 28 for receiving a respective one of fasteners 34.

Engagement members 40 and 42 are adapted to engage first and second surfaces of a structure. In at least one embodiment, engagement members 40 and 42 are adapted to engage a slatwall. First engagement member 40 can be disposed in the upper region of mount housing 10, and can be connected to the inner surfaces of front wall 12 and upper wall 14 of housing 10. First engagement member 40 comprises a base plate 44 and a brace 43 comprising vertical sides 43a and a connecting back plate 43b. The outward facing edge of base plate 44 comprises a curved or angled portion 46. As best shown in FIG. 4, when mount 1 is installed on a slatwall, base plate 44 can extend towards and possibly into a groove or slot 302 of slatwall 300. Angled portion 46 hooks onto or around one of the lips 304 in slatwall 300. As illustrated in FIG. 3, base plate 44 can also comprise one or more holes 50 therethrough for attachment to mount housing 10 by way of one or more fasteners 35. Base plate 44 may also have a hole 48 to allow for the passage of a linkage member 120 of the cam lock assembly 100, both of which are described below. Furthermore, as best shown in FIGS. 1B and 3, brace 43 extends from and reinforces base plate 44. Back plate 43b of brace 43 can be formed with a rectangular locating slot 45, which cooperates with a locating tab 13 on the inner surface of front wall 12 of mount housing 10 to properly align and locate brace 43 within mount housing 10. Brace 43 also has holes 47 therethrough, which are aligned with holes 21 in front wall 12 of mount housing 10 for attachment of brace 43 to front wall 12 by way of one or more fasteners 66.

Second engagement member 42 is disposed at a spaced apart location from first engagement member 40. In at least one embodiment, second engagement member 42 is disposed in the lower region of the mount housing 10 opposite first engagement member 40. Like first engagement member 40, the purpose of second member 42 is also to engage or “hook” into a slot 302 in slatwall 300. To achieve this purpose, second engagement member 42 can be substantially “S”-shaped and can comprise a base plate 52, a flange 54 extending from the upper edge of base plate 52, and a lower angled portion 56 extending from the lower edge of base plate 52. Upper flange 54 can have a hole 64 to receive the lower end of linkage member 120 of cam lock assembly 100. Furthermore, angled portion 56 extends from the lower edge of base plate 52 at an angle for hooking onto or around one of the lips 304 in slatwall 300. As best shown in FIGS. 3 and 4, in at least one embodiment, the proximal side of angled portion 56 can extend substantially orthogonally from base plate 52. The distal side of angled portion 56 can then extend upwardly at an angle or curve from the proximal side.

Second engagement member 42 can be connected or fastened to the lower end of linkage member 120. In one embodiment, linkage member 120 is a rod, the lower end of which can be threaded to receive a nut 124 to secure second engagement member 42 to rod 120 (see FIG. 3). It will be appreciated however that linkage member 120 can take any other suitable form, including a bolt, arm, or bar. In at least one embodiment, the position on linkage member 120 at which second engagement member 42 is secured can be adjustable. This would allow mount 1 to be adjusted for cooperation with structures having different dimensions, including slatwalls having differently spaced or sized grooves. It is also to be appreciated that in at least one embodiment, linkage member 120 can be integrally formed with or otherwise connected to second engagement member 42, thereby eliminating the need for a separate rod.

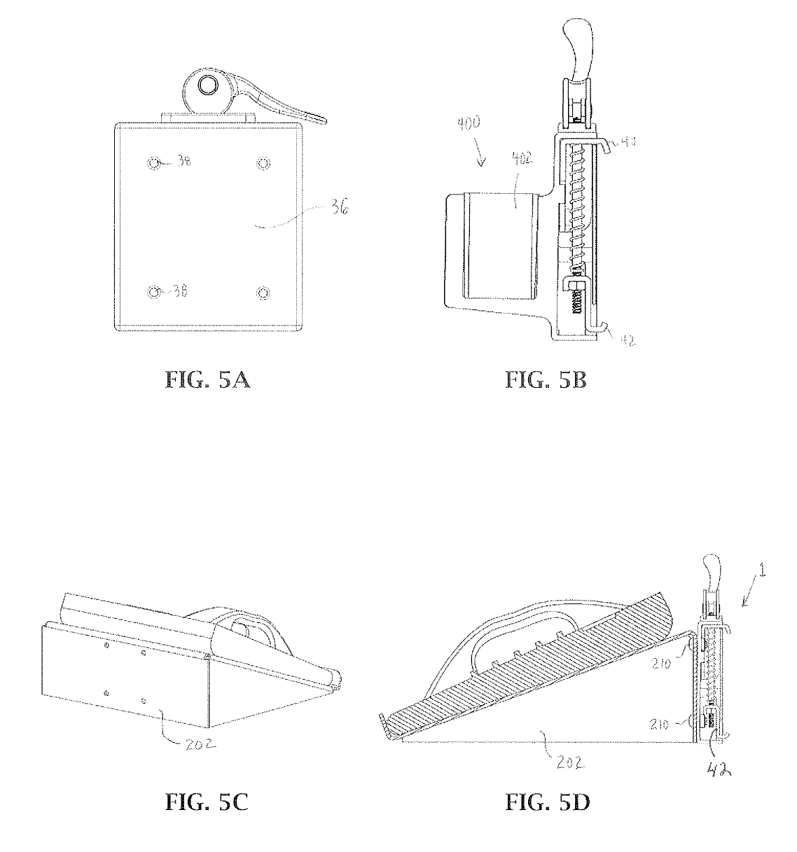

Second engagement member 42 is moveable in a vertical direction relative to mount housing 10. FIGS. 1A, 1B, 2A and 4 show second engagement member 42 in a locked or engaged position, whereas FIGS. 2B, 5B and 5D show engagement member 42 in an unlocked or disengaged position. With reference now to FIG. 3, rod 120 of cam lock assembly 100 is disposed between a cam 104 and second engagement member 42 for transmitting movement of cam 104 to second engagement member 42 as cam 104 is rotated. As previously mentioned, the distance spanned between cam 104 and second engagement member 42 can be adjustable to allow mount 1 to be adjusted for cooperation with structures having different dimensions. In at least one embodiment, the movement of second engagement member 42 is guided by mount housing 10, and in particular by the inner surfaces of housing 10. As shown best in FIG. 10, the movement of second engagement member 42 can be guided by one or more engagement member guides 30 disposed in the lower region of mount housing 10. In the embodiment shown in the Figures, cam lock mount 1 comprises a pair of guides 30 disposed in the interior of mount housing 10 on opposite sides of housing 10 at side walls 16 and 18 respectively. In addition, second engagement member 42 is retained in position substantially within the mount housing 10 and against guides 30 by rear plate 22. Guides 30 can be formed integrally with housing 10 or they can be inserts. If they are inserts, they can be made of the same material as housing 10, or some other material such as a low friction plastic or nylon.

Angled portions 46 and 56 of engagement members 40 and 42 can be of lengths that are near to or even greater than the width of mount housing 10. Increasing the lengths of angled portions 46 and 56 would spread the mount load over a larger area on the slatwall, and could therefore increase the maximum load capacity of the mount 1 and slatwall system. Engagement members 40 and 42 can be made of any suitable material of sufficient strength known in the art, including metal or plastic.

With reference now to FIG. 3, cam lock mount 1 further comprises cam lock assembly 100 for selectively locking and unlocking mount 1 to a structure such as a slatwall. Cam lock assembly 100 comprises a cam mechanism 102 having cam 104 for moving at least one of engagement members 40 or 42 as cam 104 is rotated. In the embodiment shown in the Figures, cam 104 moves second engagement member 42 as cam 104 rotates.

Cam lock assembly 100 can also comprise linkage member 120 disposed between cam mechanism 102 and second engagement member 42 for moving second engagement member 42 as cam 104 is rotated. As mentioned above, in at least one embodiment linkage member 120 is a rod.

In at least one embodiment, cam mechanism 102 has a handle 106 connected to or integrally formed with cam 104. Cam mechanism 102 can also comprise a pivot member 110 for pivotally connecting cam 104 to rod 120. In at least one embodiment, cam mechanism 102 is substantially U-shaped and cam 104 is in the form of a pair of substantially similar spaced apart cam members 105. Pivot member 110 can be disposed between the two cam members 105 and can be supported by a pair of bushings 113, each of which is fixedly seated in a hole 108 in one of the cam members 105. Pivot member 110 is rotatably connected to the cam members 105 by bushings 113, and is therefore free to rotate in relation to cam 104. As shown in FIG. 3, pivot 110 is sized and shaped such that its ends are receivable into a hole of one of bushings 113. Pivot member 110 can be connected to the upper end of rod 120 by any suitable means. In one embodiment, the upper end of rod 120 is threaded and is received into a correspondingly threaded bore 111 in pivot member 110, the axis of bore 111 being substantially perpendicular to the rotational axis of pivot member 110. Other means of connection pivot member 110 to rod 120 will occur to those skilled in the art, including a keyed connection or by use of a set screw 114, which may be screwed into an aperture 112 in pivot member 110. In the embodiment shown in FIG. 3, set screw 114 is used to bear against the end of rod 120 in pivot 110 to prevent the rod from inadvertently backing off or unscrewing.

Cam mechanism 102 can be positioned in relation to the outer surface of upper wall 14 of the mount housing 10. Cam lock mount 1 can also have a cam guide 130 disposed between cam mechanism 102 and mount housing 10 to retain cam 104 in position relative to mount housing 10. In at least one embodiment, cam guide 130 has at least one guide slot 132 for receiving and guiding cam 104. In the embodiment shown in the Figures, cam guide 130 has a pair of guide slots 132 for receiving the pair of cam members 105. Cam guide 130 can further comprise a hole 134 to allow for the passage of rod 120 therethrough. Cam guide 130 can be fastened to mount housing 10 by one or more fasteners 138, which can be accommodated by mounting holes 136 in cam guide 130.

Cam lock assembly 100 can further comprise means to bias second engagement member 42 relative to first engagement member 40. In one embodiment, the biasing means normally biases second engagement member 42 away from first engagement member 40. The biasing means can facilitate the installation of mount 1 onto a slatwall by preventing second engagement member 42 from inadvertently moving in an upwardly direction towards first engagement member 40. As shown in the Figures, in at least one embodiment the biasing means can be in the form of a coil spring 126. Ideally, guide slots 132 in the cam guide are well polished or the guide itself is made of some durable but low friction material that reduces friction between cam members 105 and guide slots 132. This will reduce the amount of force required to move handle 106, which in turn should lessen the likelihood of damage to cam mechanism 102 and upper wall 14.

Mount housing 10 serves to support other components of the cam lock mount 1, such as cam lock assembly 100 and engagement members 40 and 42. Mount housing 10 can also have a mounting surface 36 on or against which one or more accessories, accessory mounts, or other objects can be connected. As shown in FIG. 5A, in at least one embodiment the outer surface of front wall 12 of mount housing 10 serves as a mounting surface 36. Furthermore, mounting surface 36 can have one or more mounting holes 38 to receive one or more fasteners for fastening one or more accessories or accessory mounts to mount 1.

FIG. 5C shows one example of an accessory 202, and FIG. 5D illustrates one way in which an accessory can be connected to mount 1. Accessory 202 is coupled to mounting surface 36 of front wall 12 by way of one or more fasteners 210. It is to be understood that an accessory, accessory mount or other object can be connected to mount 1 by any other suitable means, including but not limited to adhesive, welding, or one or more clips or hooks. In at least one embodiment of cam lock mount 1, one or more accessories or accessory mounts can be formed integrally with mount 1. For example, FIG. 5B shows one embodiment of the mount 1 in which a mounting assembly 400 comprising a mounting bore 402 is integrally formed with mount housing 10. Mounting bore 402 can be adapted to receive an end of a support arm for supporting a lamp, monitor, or any other device, accessory or object.

The installation and locking of mount 1 on a slatwall will now be described. To prepare mount 1 for installation, cam mechanism 102 is rotated in the direction that moves second engagement member 42 away from first engagement member 40. FIGS. 2B, 5B and 5D show one embodiment of mount 1 in this “unlocked” state. Mount 1 can then be positioned on a slatwall such that first and second engagement members 40 and 42 are substantially aligned with two different grooves or slots in the slatwall. Cam mechanism 102 is then rotated in the opposite direction to the direction described above, meaning in a direction that moves second engagement member 42 towards first engagement member 40, until second engagement member 42 compressively engages an opposing lip 304 of the respective slot 302 in the slatwall. FIGS. 1A, 1B, 2A and 4 show one embodiment of mount 1 in this “locked” state. Cam mechanism 102 is maintained in the locked state by, for example, locating holes 108 in cam members 105 eccentrically relative to the central pivot axis of cam 104 in that the action of spring 126 pushing against engagement member 42 results in rod 120 pulling downwardly on handle or lever 106 to bias it into the locked position. To rotate cam mechanism 102 into the unlocked position, an increased force is necessary to initially compress spring 126 until holes 108 align with and then move past the center pivot axis of cam 104.

It will occur to those skilled in the art that other means exist of selectively locking cam mechanism 102 in place when the second engagement member is in the locked position. For example, one or more locking mechanisms can be employed. These locking mechanisms include spring clips, a hook that can connect to handle 106 to lock the handle in place, and any other locking mechanisms known in the art.

The embodiments of cam lock mount 1 described herein and illustrated in the Figures engages and locks onto a slatwall by moving one of the engagement members towards a second engagement member, in effect “clamping” onto the slatwall. In these embodiments, angled portions 46 and 56 of engagement members 40 and 42 extend inwardly. More specifically, angled portion 46 of first engagement member 40 extends at a downwardly angle from base plate 44, while angled portion 56 of second engagement member 42 extends at an upwardly angle from base plate 52.

It will be appreciated that in at least one alternative embodiment of mount 1, mount 1 can engage and lock onto a slatwall by moving one of the engagement members away from the other engagement member. In such an alternative embodiment, angled portions 46 and 56 of engagement members 40 and 42 will extend in the opposite directions (i.e. outwardly).

This difference can be more clearly described with reference to FIG. 4. In the embodiment shown in the Figures, angled portion 46 of first engagement member 40 extends at a downwardly angle to “hook” onto a lower lip 304 of a slatwall groove 302. Angled portion 56 of second engagement member 42 extends at an upwardly angle. In contrast, in the at least one alternative mount, angled portion 46 of first engagement member would extend upwardly to engage an upper lip 304 or side of a groove 302. Angled portion 56 of second engagement member 42 would extend downwardly to engage a lower lip 304 of a second groove 302.

It will be further appreciated that in at least one embodiment first engagement member 40 will be movable relative second engagement member 42 rather than the second 42 being moveable relative to the first 40. In addition, in at least one other embodiment, both first and second engagement members 40 and 42 will be moveable relative to mount housing 10.

It will also be appreciated that in at least one embodiment of the mount 1, cam lock assembly 100 need not have a linkage member 120 to move one engagement member relative to the other engagement member. Rather, cam 104 could act directly on one of the engagement members (e.g. first engagement member 40) to move the engagement member into a locked position. Or there might be a separate cam for each of members 40 and 42. Members 40 and 42 might themselves be unitary pieces as shown or they might be split into segments.

The previous detailed description is provided to enable any person skilled in the art to make or use the present invention. Various modifications to those embodiments will be readily apparent to those skilled in the art, and the generic principles defined herein may be applied to other embodiments without departing from the spirit or scope of the invention described herein. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

What is claimed:

1. A cam lock mount for mounting an object on a structure having at least a first surface and a second surface, the cam lock mount comprising:
a mount housing;
a first engagement member coupled to the mount housing for engaging the first surface of the structure;
a second engagement member for engaging the second surface of the structure, the second engagement member coupled to the mount housing at a spaced apart location from the first engagement member;
a cam lock assembly supported by the mount housing and comprising:
a rotatable cam mechanism having cam means for moving at least one of the first engagement member and the second engagement member between at least a locked position connecting said mount to the structure and an unlocked position in which the mount is not connected to the structure.

2. The cam lock mount of claim 1 wherein the cam lock assembly further comprises a linkage member disposed between said cam means and at least one of the first engagement member and the second engagement member for transmitting movement of said cam means to the at least one of the first engagement member and the second engagement member.

3. The cam lock mount of claim 1 wherein said cam means and at least one of said first and second engagement members are connected to said linkage member to be at a selected distance apart.

4. The cam lock mount of claim 3 wherein the distance between said cam means and the at least one of the first engagement member and the second engagement member is adjustable.

5. The cam lock mount of claim 2 wherein the linkage member is a rod.

6. The cam lock mount of claim 2 wherein the cam lock assembly includes a pivot member for pivotally connecting said cam means to the linkage member.

7. The cam lock mount of claim 1 wherein said cam means comprise at least two spaced apart cam members.

8. The cam lock mount of claim 5 further comprising a cam guide for retaining the cam mechanism in alignment relative to the mount housing.

9. The cam lock mount of claim 8 wherein the cam guide comprises at least one guide slot for respectively receiving thereinto and guiding the rotational movement of respective ones of said cam members.

10. The cam lock mount of claim 1 further comprising a biasing mechanism for biasing at least one of the first engagement member and the second engagement member relative the other one of the first engagement member and the second engagement member.

11. The cam lock mount of claim 10 wherein the biasing mechanism is a spring.

12. The cam lock mount of claim 1 wherein said first engagement member is fixedly connected to said housing.

13. The cam lock mount of claim 12 wherein said second engagement member is moveably supported by said housing, said linkage member being connected adjacent one end thereof to said cam means and adjacent the other end thereof to said second engagement member whereby rotation of said cam means moves said second engagement member between said locked and unlocked positions thereof.

14. The cam lock mechanism of claim 13 wherein said spring normally urges said first and second engagement members apart.

15. The cam lock mechanism of claim 8 wherein said housing has a front wall, upper and lower walls, side walls and a removable back wall for accessing the housing's interior.

16. The cam lock mount of claim 15 wherein said cam guide is fixedly connected to an exterior surface of said housing's upper wall.

17. The cam lock mount of claim 16 wherein axially aligned holes are formed through said cam guide, said upper wall and said first and second engagement members for passage of said rod therethrough.

18. The cam lock mount of claim 17 wherein the end of the rod passing through said second engagement member is threaded, said second engagement member being retained on said rod by a correspondingly threaded fastener that can be adjusted to selectively adjust the distance between said first and second engagement members.

19. The cam lock mount of claim 18 wherein said spring is disposed concentrically around said rod to extend between said first and second engagement members to normally bias them apart.

20. The cam lock mount of claim 1 further including a lever fixedly connected to said cam means for rotating the cam means between a first position in which said first and second engagement members are in said locked position and a second position in which said first and second engagements are in said unlocked position.

21. The cam lock mount of claim 20 wherein said spring biases said lever into said first position when said first and second engagement members are in said locked position.

22. The cam lock mechanism of claim 1 wherein each of said first and second engagement members includes an angled portion that extends rearwardly from said housing's back wall for respectively engaging the first and second surfaces of the structure.

23. The cam lock mount of claim 1 wherein the structure is a slatwall, said first surface being a slot in said slat wall and said second surface being another, spaced apart, slot in the slat wall.

24. The cam lock mount of claim 23 wherein the angled portion of the first engagement member is receivable into the first slot and the angled portion of the second engagement member is receivable into the second slot, said angled portions clamping onto said slots when said first and second engagement members are moved into the locked position thereof to secure said cam lock mount to said slatwall.

25. The cam lock of claim 24 wherein said first and second engagement members are moved towards one another when in said locked position thereof.

26. The cam lock mechanism of claim 24 wherein said first and second engagement members are moved away from one another when in said locked position thereof.

27. The cam lock mechanism of claim 1 wherein said housing is adapted for connection of an object thereto whereby the object can be supported from said structure.

28. The cam lock mount of claim 27 wherein the object is an accessory mount.

29. The cam lock mount of claim 28 wherein the accessory mount is connected to a front surface of the housing.

30. The cam lock mount of claim 28 wherein the accessory mount is formed integrally with said housing.

31. A clamp for connection to a structure, the clamp comprising:
a first clamping member for engaging the structure at a first location;
a second clamping member for engaging the structure at a second location spaced apart from the first location; and
actuating means for moving at least one of said first or second clamping members between a structure engaging position and a structure releasing position, the actuating means comprising a linkage member operatively connected to at least one of said first and second clamping members and a lever mechanism operatively connected to the linkage member, the lever mechanism being pivotable for moving said linkage member between said structure engaging and releasing positions.

32. The clamp of claim 31 wherein the structure is a slat wall having horizontal slots formed therein, the first location being one of said slots and the second location being another of said slots.

33. The claim of claim 32 additionally comprising a support structure for said first and said second clamp members and said actuating means, said support structure being adapted for connection to an object wherein the object is thereby supported by access by a user of the object.
